(19) United States
(12) Patent Application Publication
(10) Pub. No.: US 2015/0261795 A1
(43) Pub. Date: Sep. 17, 2015

(54) COMPUTER-BASED SYSTEM AND METHOD OF STRUCTURING A SPECIALIZED DATABASE FOR AUTOMATICALLY GENERATING FINANCIAL DISCLOSURE DOCUMENTS

(71) Applicant: SeyfarthLean Consulting LLC, Chicago, IL (US)

(72) Inventors: Andrew Medeiros, Chicago, IL (US); Andrew Baker, Oak Park, IL (US); Georgia Quinn, New York, NY (US)

(73) Assignee: SeyfarthLean Consulting LLC, Chicago, IL (US)

(21) Appl. No.: 14/644,891

(22) Filed: Mar. 11, 2015

Related U.S. Application Data
(60) Provisional application No. 61/951,730, filed on Mar. 12, 2014.

(51) Int. Cl. G06F 17/30; G06Q 10/06; G06Q 40/00

(52) U.S. Cl. CPC G06F 17/30292; G06Q 40/00; G06Q 10/06; G06F 17/30864

(57) ABSTRACT

Special purpose machines and methods of transforming raw disclosure information into a particularly structured dataset or database that can optimally store and present disclosure information for processing that complies with specific rules regarding securities offerings are described. Raw disclosure information provided by an issuer is processed, parsed, and strategically partitioned within a database.

### RELATED APPLICATION DATA

This application claims priority to U.S. Provisional Patent Application Ser. No. 61/951,730, filed Mar. 12, 2014, which is incorporated herein by reference.

### FIELD OF TECHNOLOGY

The present disclosure relates generally to systems and methods for constructing and processing structured databases.

### BACKGROUND

Many companies around the world conduct offerings to gain access to additional capital. These offerings involve securities purchased by other companies or individuals either having or lacking the requisite financial knowledge needed to provide appropriate information or used to make sound investment decisions.

In order to protect the broadest range of potential investors, there are various rules that require disclosure of certain information to ensure potential investors are aware of information deemed relevant to making sound investment decisions. This information is comprehensive, detailed, and spans various aspects of the issuer.

Due to the magnitude of required disclosures, teams of individuals, often times lawyers, spend exorbitant amounts of time to perform the arduous tasks of gathering this information, processing the information to ensure compliance with offering rules, and transmitting the compliant information to the proper authority. This costs the issuer substantial time and money in labor (for example attorneys' fees), due to extensive manual processing needed to compile the information.

### SUMMARY

The present disclosure relates to systems and methods involving a special purpose machine that automates building of a structured data set or database of pertinent information, and the processing of the disclosure information, thereby optimizing the processed disclosure information provided for private placement memorandum, etc.

An automated intake questionnaire is filled out by an issuer and received by the special purpose computer. Simultaneously or at a time after the intake questionnaire is received, the raw disclosure information input according to the questionnaire is parsed by the computer and structured/stored within specific partitions of a database. The parsed and partitioned input information is processed into a format within a particularly structured database optimized for auto-populating into a private placement memorandum (PPM) form or report, or some other private placement document. A compliance analysis is conducted regarding the processed disclosure information contained within the private placement form to determine whether the processed disclosure information complies with the specific offering rules. The compliance analysis may be an automated process performed by the specific purpose computer disclosed herein, or may be a manual process conducted by an individual. If the processed disclosure information is determined to be noncompliant with the applicable offering rules, a file containing the processed disclosure information is stored within the database for further review and/or revisions. When the file is stored, portions of the information of the file are stored within special partitions of the database. Alternatively, if the processed disclosure information is compliant with the applicable, e.g., offering rules, the file containing the processed disclosure information is uploaded to a portal for dissemination or automated publication.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference number in different figures indicates similar or identical items or features.

FIG. 1 illustrates a flow diagram of a method for providing processed disclosure information in a format compliant with specific rules according to the present disclosure.

FIG. 2 illustrates a system for developing a structured database and providing processed disclosure information in a format compliant with specific rules according to the present disclosure.

FIG. 3 illustrates processing of raw disclosure information for optimized association within an issuer partition of a structured database as processed disclosure information according to the present disclosure.

FIG. 4 illustrates processing of raw disclosure information for configuration within an issuer partition according to the present disclosure.

FIG. 5 illustrates processing of raw disclosure information for optimized association within a securities/offering partition of a structured database as processed disclosure information according to the present disclosure.

FIG. 6 illustrates processing of raw disclosure information for optimized association within a staff partition of a structured database as processed disclosure information according to the present disclosure.

FIG. 7 illustrates processing of raw disclosure information for configuration within a staff partition according to the present disclosure.

FIG. 8 illustrates processing of raw disclosure information for optimized association within a shareholder partition of a structured database as processed disclosure information according to the present disclosure.

FIG. 9 illustrates processing of raw disclosure information for configuration within a shareholder partition according to the present disclosure.

FIG. 10 illustrates processing of raw disclosure information for optimized association within a business description partition of a structured database as processed disclosure information according to the present disclosure.

FIG. 11 illustrates processing of raw disclosure information for optimized association within a risk factor partition of a structured database as processed disclosure information according to the present disclosure.

FIG. 12 illustrates processing of raw disclosure information for configuration within a risk factor partition according to the present disclosure.

FIG. 13 illustrates processing of raw disclosure information for optimized association within a financial condition partition of a structured database as processed disclosure information according to the present disclosure.

FIG. 14 illustrates processing of raw disclosure information for optimized association within an ownership partition of a structured database as processed disclosure information according to the present disclosure.

FIG. 15 illustrates processing of raw disclosure information for configuration within an ownership partition according to the present disclosure.

FIG. 16 illustrates processing of raw disclosure information for optimized association within a related party transaction partition of a structured database as processed disclosure information according to the present disclosure.

FIG. 17 illustrates processing of raw disclosure information for configuration within a related party transaction partition according to the present disclosure.

### DETAILED DESCRIPTION

Apparatus, systems, and methods for building a structured database containing optimally stored information within specific partitions of the structured database to produce a disclosure document compliant with specific rules are described. A special purpose computer receives raw disclosure information. The raw disclosure information is parsed and processed to store the parsed raw disclosure information within particularized partitions of the structured database as processed disclosure information. Optimal storage allows for auto-population of a private placement memorandum or private placement document. The special purpose computer additionally processes the private placement memorandum or document, and the processed disclosure information contained therein, to ensure compliance of the document and processed disclosure information with specific offering rules. However, this compliance analysis may be manual performed by an individual without departing from the scope of the present disclosure. If the document and/or its processed disclosure information is determined noncompliant with the specific rules, a file containing the document and its processed disclosure information is stored for further review and/or revision. When this file is stored, the processed disclosure information related by the file may be stored within specific partitions of the database. When the document and its processed disclosure information is compliant with the specific rules, the document and its processed disclosure information may be uploaded to a portal for dissemination.

The special purpose machine described herein transforms raw disclosure information provided by an issuer into a particularly structured dataset or database that can optimally store and present disclosure information for processing that complies with specific rules regarding securities offerings. Specifically, the raw disclosure information is strategically partitioned within a database in a manner that allows processing of the raw disclosure information into processed disclosure information to occur automatically and expediently. The partitions within the database are categorized according to topics for processing and conforming to areas of the specific offering rules to be complied with for appropriate disclosure.

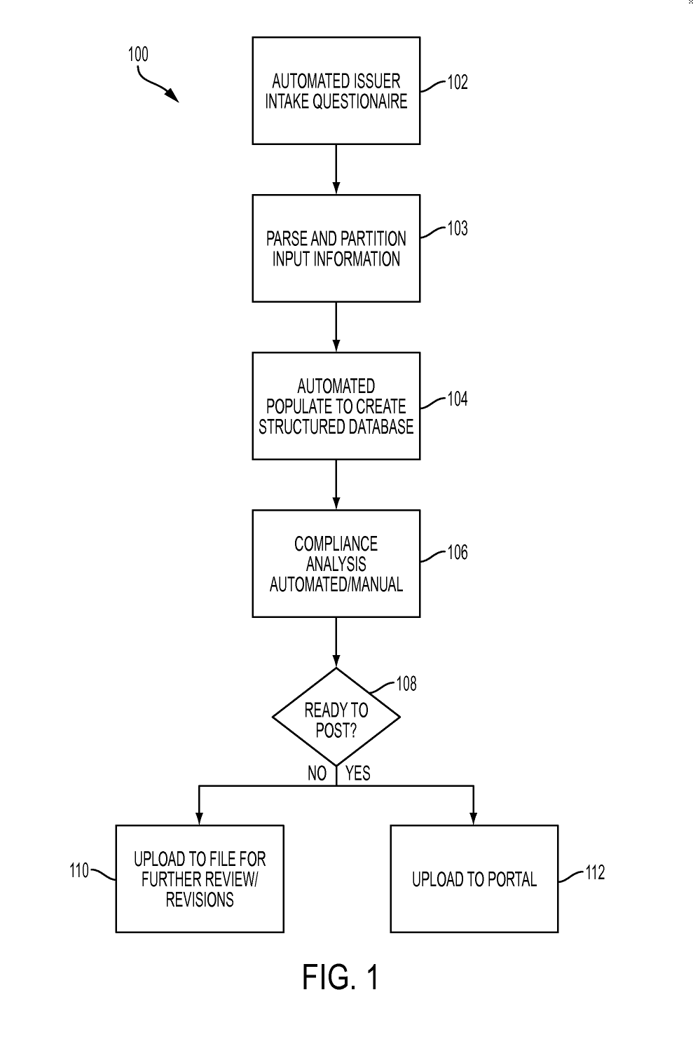

FIG. 1 illustrates a flow diagram of a method 100 for providing processed disclosure information in a format compliant with specific offering rules. An automated intake questionnaire is filled out by an issuer and received by the special purpose computer disclosed herein (illustrated as 102). Simultaneously or at a time after the intake questionnaire is received, the raw disclosure information input according to the questionnaire is parsed by the computer and structured/stored within specific partitions of a database (illustrated as 103). The parsed and partitioned input information is processed into a format within a particularly structured database optimized for auto-populating into a private placement memorandum (PPM) form or report, or some other private placement document (illustrated as 104). A compliance analysis is conducted regarding the processed disclosure information contained within the private placement form (illustrated as 106) to determine whether the processed disclosure information complies with the specific offering rules (illustrated as 108). The compliance analysis may be an automated process performed by the specific purpose computer disclosed herein, or may be a manual process conducted by an individual. If the processed disclosure information is determined to be noncompliant with the applicable offering rules, a file containing the processed disclosure information is stored within the database for further review and/or revisions (illustrated as 110). When the file is stored, portions of the information of the file are stored within special partitions of the database. Alternatively, if the processed disclosure information is compliant with the applicable, e.g., offering rules, the file containing the processed disclosure information is uploaded to a portal for dissemination or automated publication (illustrated as 112).

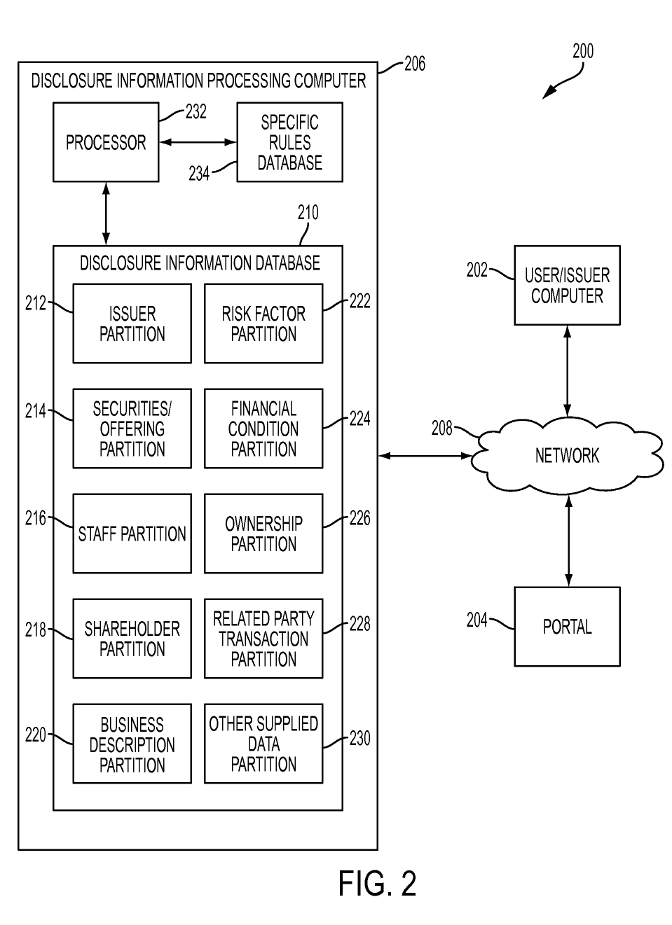

FIG. 2 illustrates a system 200 for building a structured database optimized for providing processed disclosure information in a format compliant with specific offering rules. The system 200 includes a user/issuer computer 202 and a portal 204, each being in communication with a disclosure information processing computer 206 via a network 208.

The user/issuer computer 202 is a computer that receives raw disclosure information from a user/issuer that desires an offering be made based on the raw disclosure information. The user/issuer computer 202 communicates/transmits the raw disclosure information to the disclosure information processing computer 206, for processing of the raw disclosure information into processed disclosure information compliant with relevant offering rules. The received raw disclosure information is processed by the processor 232 to produce processed disclosure information selectively stored within the specific partitions disclosed herein. The raw disclosure information may be provided all at once, thereby requiring the processor 232 to determine which partition specific portions of the raw disclosure information pertain.

The portal 204 is a device or display that communicates a generated PPM or other document to recipients that may want to purchase an interest in the issuer, i.e., a security of an offering pertaining to the disclosure information. Communication of the document may be initiated by an individual, or it may be automatic. Automatic communication of the document may be triggered when the PPM or other document is generated or when the PPM or other document has been reviewed and deemed compliant with relevant offering rules. Review of the PPM or other document to ensure compliance may occur through human effort or it may be automatic via the processor 232.

The network 208 is a communication and transmission platform that receives and transmits data/information between the issuer computer 202 and the disclosure information processing computer 206, and between the portal 204 and the disclosure information processing computer 206. The network 208 may be, for example, a Wide Area Network, Ethernet, wireless, Bluetooth, and the like.

The processor 232 of the disclosure information processing computer 206 parses the received raw disclosure information and processes it to be stored as processed disclosure information within partitions of a structured disclosure information database 210. Such processing includes determining which portions of the raw disclosure information relate to which partition of the structured database 210. A non-limiting list of potential partitions includes an issuer partition 212, securities/offering partition 214, staff partition 216, shareholder partition 218, business description partition 220, risk factor partition 222, financial condition partition 224, ownership partition 226, related party transaction partition 228, and other supplied data partition 230. The raw disclosure information specific to a single offering is related throughout the partitions 212, 214, 216, 218, 220, 222, 224, 226, 228, 230 by a unique offering file identifier or session ID.

When the disclosure information processing computer 206 receives raw disclosure information pertaining to an offering for the first time, a session ID is automatically assigned. The session ID is passed into the partitions 212, 214, 216, 218, 220, 222, 224, 226, 228, 230 along with the processed disclosure information. Depending upon implementation, the session ID may be passed into a partition only if processed disclosure information is being stored therein or the session ID may be passed into some or all of the partitions regardless of whether processed disclosure information is being stored in the respective partition. Put another way, depending upon implementation, processed disclosure information may or may not need to be stored within a partition for the partition to receive the session ID. Transmission of the session ID to the partitions allows for processing of the raw disclosure information to occur in a lean fashion by not repeating information within multiple partitions. This allows the processed disclosure information specific to a single offering to be automatically pinpointed to be included within a PPM or other document described herein.

The processor 232 is in communication with the structured disclosure information database 210, thereby allowing the processor 232 to perform the processing functions disclosed herein in order to process the raw disclosure information into the partitioned structured disclosure database and processed disclosure information compliant with specific offering rules. To ensure compliance, the processor 232 is also in communication with a specific rules database 234 that stores data/information pertaining to applicable offering rules. While it is illustrated that data/information pertaining to the specific rules is contained within the disclosure information processing computer 206, one skilled in the art should appreciate that the processor 232 may access a location external to the computer 206, via the network 208, that stores the data/information pertaining to the specific rules being analyzed. Such remote access of the specific rules data over the network 208 may include the processor 232 directly accessing a database, or may also include the processor 232 reading a website or some other information source to obtain the desired specific rules data/information, for example.

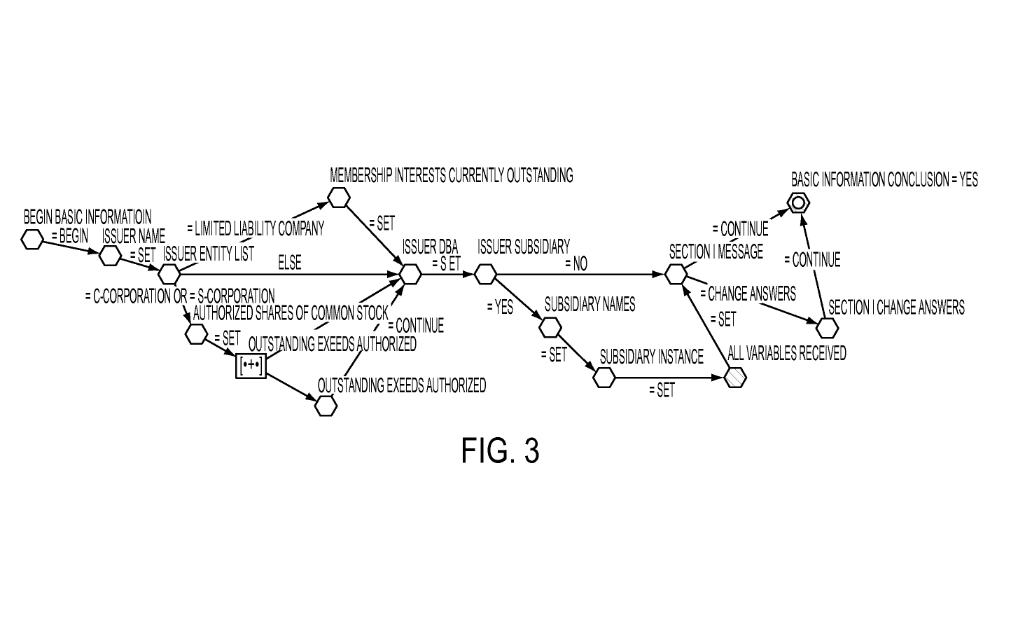

FIG. 3 illustrates processing of the raw disclosure information to be stored within the issuer partition 212 as processed disclosure information. Such information relates to the entity/issuer conducting the offering. Sub-lists/sections of the issuer partition 212 implemented in the particularly structured database are invoked if the issuer does business under other names, previously did business under other names, or is qualified to do business in jurisdictions other than the jurisdiction in which it was formed. Additionally, the issuer partition 212 within the structured database contains a set of lists that are populated if the issuer has subsidiaries. The processed disclosure information stored within the issuer partition 212 includes, for example, the legal name of the issuer, any names under which the issuer is doing business, i.e., d/b/a names, any previous name used by the issuer, type of entity of the issuer, the state the issuer is organized in, the date of formation of the issuer, any states other than the state of organization in which the issuer is qualified to do business, any foreign qualifications that apply to the issuer, the physical address of the issuer, the website of the issuer, whether the issuer has any subsidiaries, and whether the issuer has conducted any offerings under the specific rules in the past. If the issuer has subsidiaries, this aforementioned information contained within the issuer partition 212 is also gathered with respect to each subsidiary. Further, for each subsidiary, outside ownership information is stored.

Using the raw disclosure information, the issuer's entity type, e.g., Limited Liability Company (“LLC”) or Corporation, is determined. If the issuer is an LLC, membership interests currently outstanding for the LLC are determined. If, on the other hand, the issuer is a corporation, an amount of authorized shares of common stock for the corporation is determined, and whether an amount of outstanding stock exceeds the amount of authorized stock is assessed. If subsidiary information is contained within the basic partition 212, the aforementioned processing described herein with reference to FIG. 3 is performed for each subsidiary.

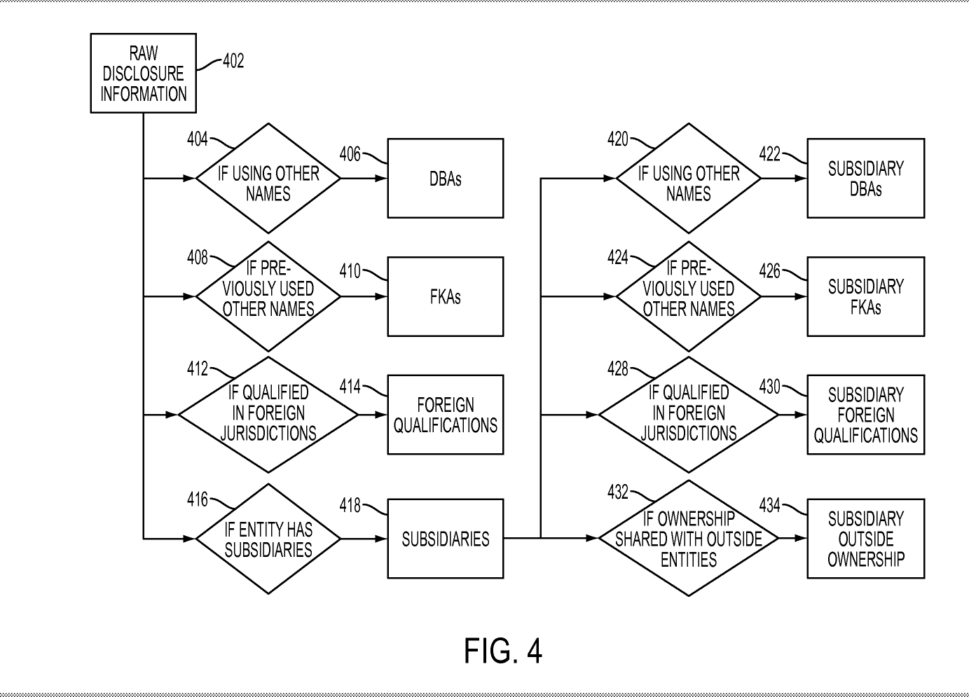

FIG. 4 depicts illustrative processing of the raw disclosure information 402 for configuration within the issuer partition 212. The processor 232 illustrated in FIG. 2 performs the functions described with reference to FIG. 4. The raw disclosure information 402 is processed to determine whether the issuer has any d/b/a names (illustrated as 404), and that information is stored within a DBA section or field 406 of the issuer partition 212. The raw disclosure information 402 is also processed to determine whether the issuer used any other names in the past (illustrated as 408). Such past names information is stored within a FKA, i.e., Formerly Known As, section or field 410 of the issuer partition 212. Moreover, the raw disclosure information 402 is processed to determine whether the issuer is qualified in foreign jurisdictions (illustrated as 412), and such foreign qualification information is stored within a foreign qualifications section 414 of the issuer partition 212. Additionally, the raw disclosure information 402 is processed to determine whether the issuer has any subsidiaries (illustrated as 416), and any provided subsidiary name is stored within a subsidiaries section 418 of the issuer partition 212. For each subsidiary identified, processing of the raw disclosure information 402 (illustrated as 420, 424, 428) similar to that illustrated by 404, 408, 412 is performed, and any corresponding information is stored within a subsidiary DBA section 422, subsidiary FKA section 426, or subsidiary foreign qualifications section 430 of the issuer partition 212 respectively. Furthermore, for each subsidiary, the raw disclosure information 402 is processed to determine whether ownership of the respective subsidiary is shared with one or more outside, i.e., non-issuer related, entities (illustrated as 432). Information corresponding thereto is stored within a subsidiary outside ownership section 434 of the issuer partition 212.

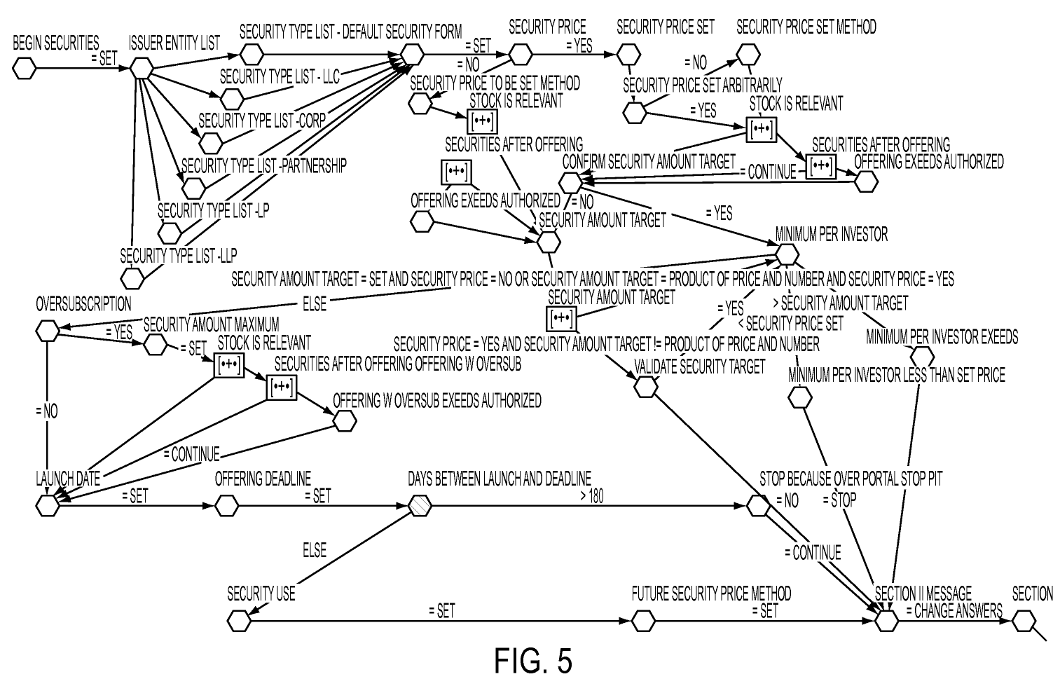

FIG. 5 illustrates processing of the raw disclosure information to be stored within the securities/offering partition 214 as processed disclosure information. The information contained within the securities/offering partition 214 relates to the offering itself, and varies based on the type of offering and type of security being offered. The processed disclosure information stored within the securities/offering partition 214 includes, for example, the type of security being offered, the number of securities being offered, the price for the securities, how the price was determined, how the price will be determined if not currently known, how the issuer will determine the value of the securities being offered in the future, the target amount of money the issuer is attempting to raise, the maximum offering amount the issuer will accept, whether oversubscriptions are acceptable, a target launch date, a deadline to reach the target offering amount, a description of how the issuer intends to use the offering proceeds, whether the securities being offered are basic common stock, what voting rights (if any) the securities will have, and what anti-dilution rights (if any) the securities will have.

The type of entity of the issuer is determined by accessing the entity information stored within the issuer partition 212. This entity information is used to determine the type of security that may be offered by the issuer. The type of security that may be offered is thereby compared with the security type indicated within the raw disclosure information to ensure the type of security being offered is acceptable.

Moreover, it is determined whether a set security price is provided within the raw disclosure information. If a security price is provided, it is determined whether the raw disclosure information contains a method for calculating value of the security in the future. Furthermore, a total number of outstanding shares the issuer will have after the offering and whether that total number of outstanding shares exceeds an authorized outstanding stock number are determined.

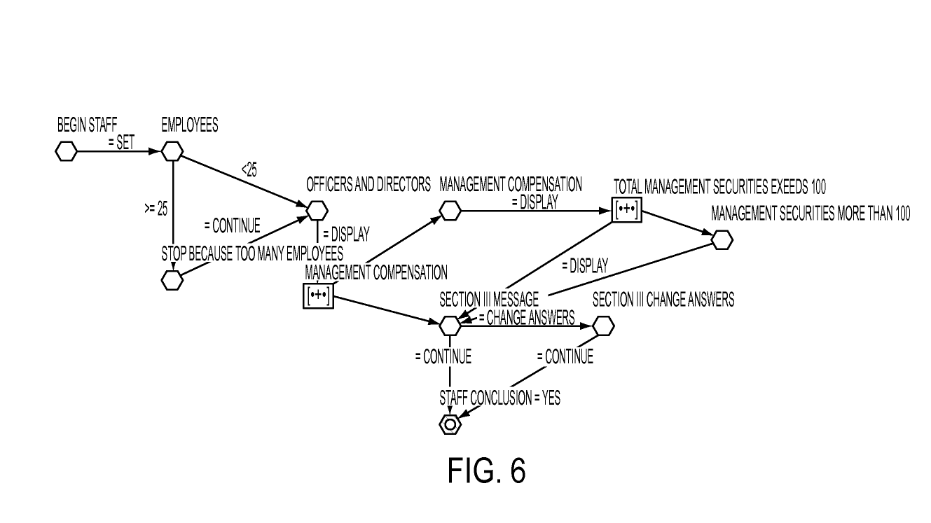

FIG. 6 illustrates processing of the raw disclosure information to be stored within the staff partition 216 as processed disclosure information. The information contained within the staff partition 216 relates to employees and management of the company. Sub-lists that may be linked within this partition of the structured database breakout the officers and directors of the issuer, their educations and employment history, compensation (if any), and the like. The processed disclosure information stored within the staff partition 216 includes, for example, the current number of employees of the issuer, the names of the directors and any other person occupying a similar status or performing a similar function of the issuer, the names of the officers of the issuer, and information pertaining to management with equity. The information pertaining to the directors and officers further includes all positions and offices held with the issuer and the date of such position(s) held, the principal occupation and employment during the last three years, whether they are currently employed by another company, equity compensation for the current year, and equity compensation for the previous year.

With respect to the raw disclosure information contained within the staff partition 216, it is determined whether the provided number of issuer employees exceeds a ceiling number of employees. If the provided number exceeds the ceiling number, the issuer may be requested to confirm the provided number of issuer employees. For example, the ceiling number of issuer employees may be 100 employees.

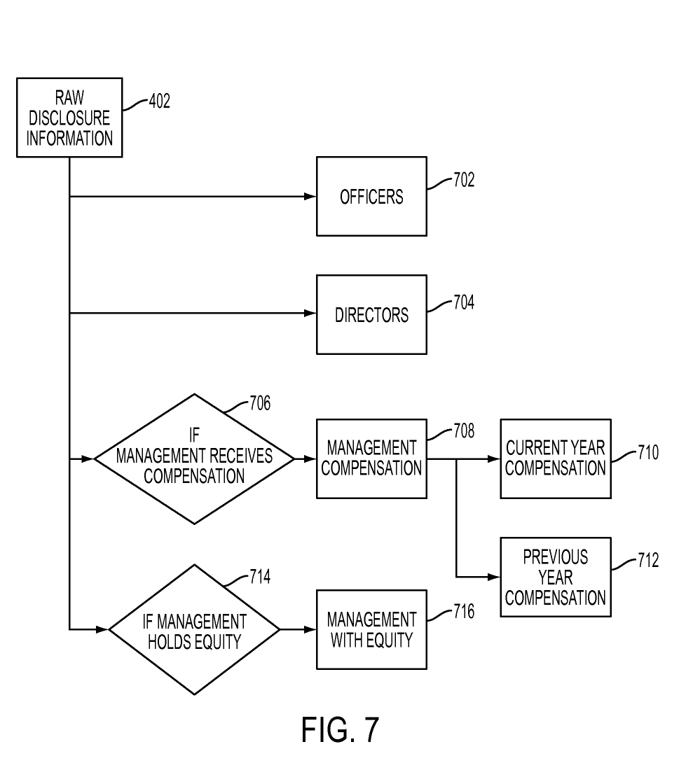

FIG. 7 depicts illustrative processing of the raw disclosure information 402 for configuration within the staff partition 216. The processor 232 of FIG. 2 performs the functions described with reference to FIG. 7. If the raw disclosure information 402 evidences the issuer's officers and directors, that information is stored within officers and directors sections or fields 702, 704 of the staff partition 216 respectively. The raw disclosure information 402 is processed to determine whether management of the issuer receives compensation (illustrated as 706). If such information exists, it is stored within a management compensation section 708 of the staff partition 216. The information contained within the management compensation section 708 is further parsed to include compensation values for the current year and previous year within current year compensation and previous year compensation sections 710, 712 respectively. The raw disclosure information 402 is further processed to determine whether management of the issuer holds equity in the issuer (illustrated as 714). The information corresponding thereto is stored within a management with equity section 716 of the staff partition 216.

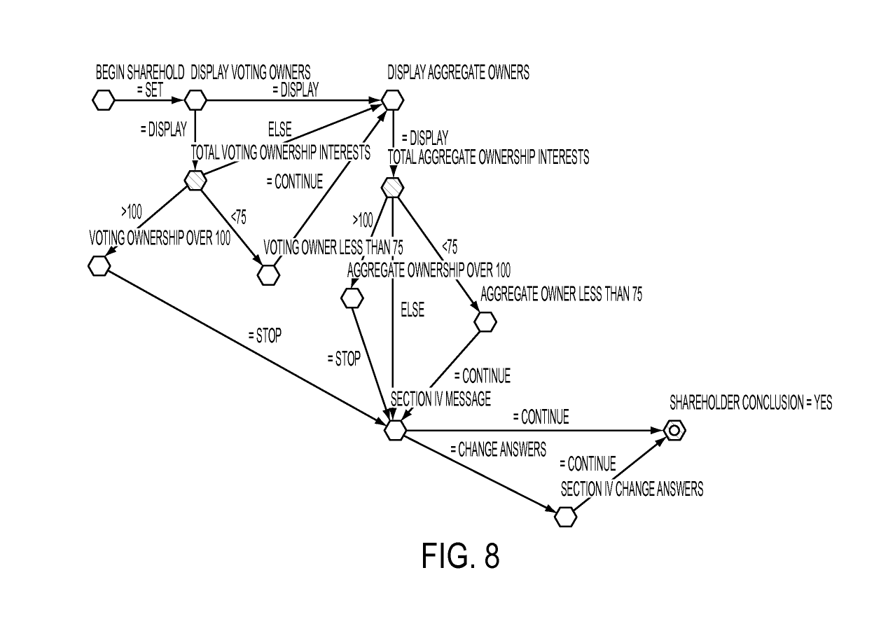

FIG. 8 illustrates the processing to associate the raw disclosure information to be stored within the shareholder partition 218 as processed disclosure information. The information contained within the shareholder partition 218 relates to persons or entities that hold interests in the issuer and the size of those interests. Accordingly, the processed disclosure information stored within the shareholder partition 218 of the structured database includes, for example, the name of each person who is a beneficial owner of at least 20% of the issuer's outstanding voting equity securities calculated on the basis of voting power and what percentage each person owns, the names of all other beneficial owners of at least 20% of the issuer's aggregate outstanding equity securities and the percentage each person owns, aggregate ownership of the issuer, and voting ownership of the issuer.

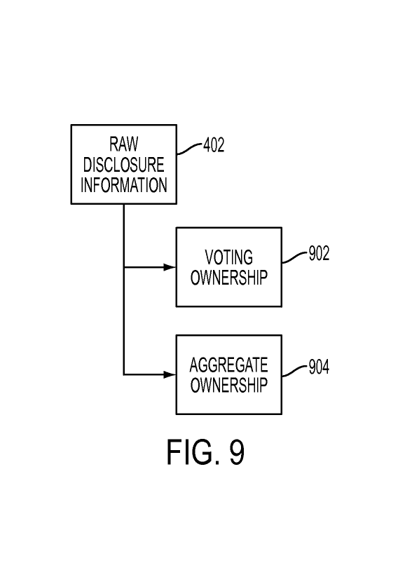

FIG. 9 depicts illustrative processing of the raw disclosure information 402 for configuration within the shareholder partition 218. The processor 232 performs the functions described with reference to FIG. 9. If the raw disclosure information 402 contains information evidencing voting ownership or aggregate ownership of the issuer, that information is stored within a voting ownership or aggregate ownership section 902, 904 of the shareholder partition 218 respectively.

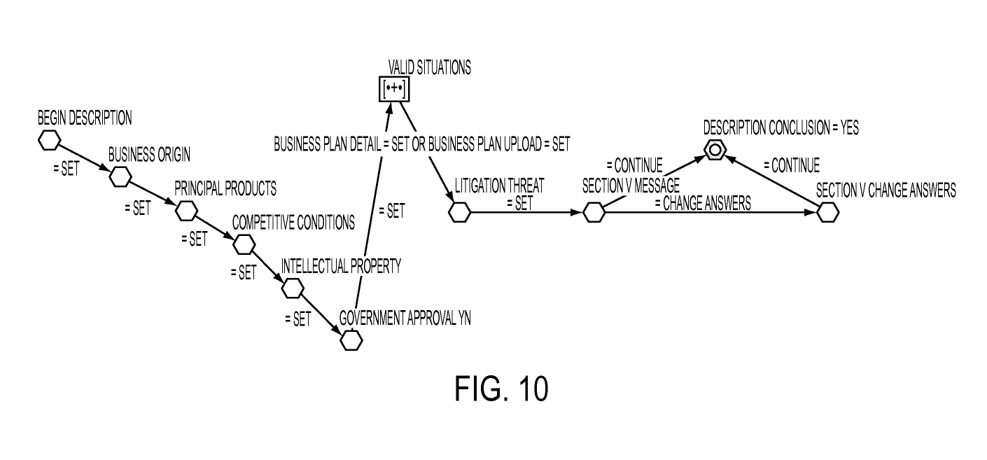

FIG. 10 illustrates processing of the raw disclosure information to be stored within the business description partition 220 as processed disclosure information. The information contained within the business description partition 220 relates to business operations of the issuer. Further, the information stored within this partition is used throughout the PPM or other disclosure document, produced using the processed disclosure information from multiple partitions related by a unique file identifier, to paint a picture of the issuer's operations. Moreover, the information contained within the business description partition 220 partially or wholly dictates whether sections of the PPM or other disclosure document are populated during automation of the document and, in some cases, triggers additional sections to be populated by follow up disclosure information, which is received after the document is automatically populated. The raw disclosure information stored within the business description partition 220 of the structured database includes, for example, the history/origin of the business, general business information, the issuer's business plan going forward, and whether there is any litigation currently threatened or pending against the issuer, its affiliates, or any of its officers or directors. The history/origin raw disclosure information includes, for example, how the issuer was started/founded, whether the issuer or any of its founders have undergone bankruptcy or the like in the past 10 years, and whether the issuer has undergone any material reclassification, merger, consolidation or purchase or sale of a significant amount of assets not in the ordinary course of business. The general business information includes, for example, the issuer's principal products or services and their markets, the issuer's distribution methods, the status of any publicly announced new product or service, the issuer's competitive business conditions, sources and availability of raw materials required by the issuer, whether the issuer is dependent on one or a few major customers and descriptions of such customers, whether the issuer uses any patents, trademarks, licenses, franchises, concession, royalty agreements, or labor contracts, and the details pertaining to such intellectual property, government approval of principal products or services, effect of existing and probable governmental regulations on the issuer, costs and effects of compliance with environmental laws, and costs of research and development and who bears such costs.

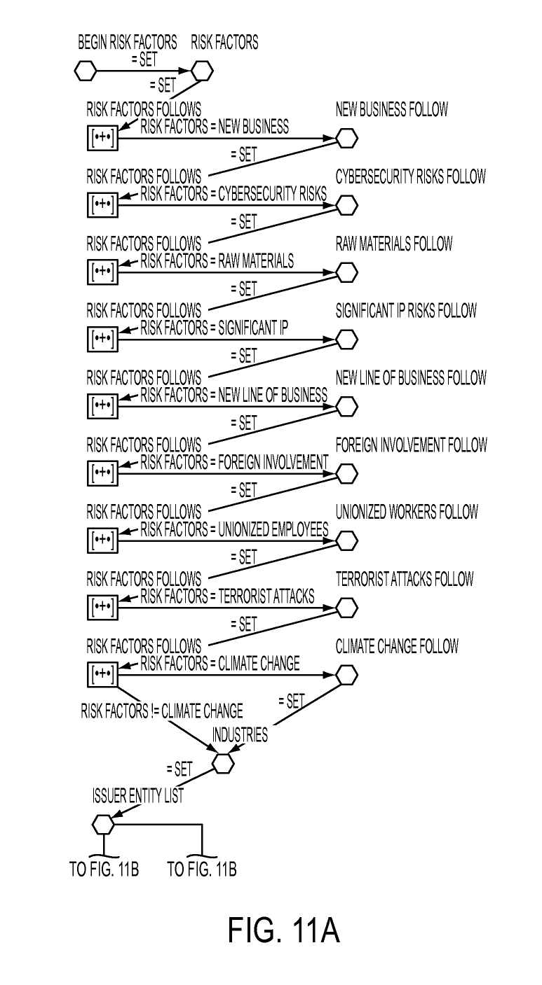

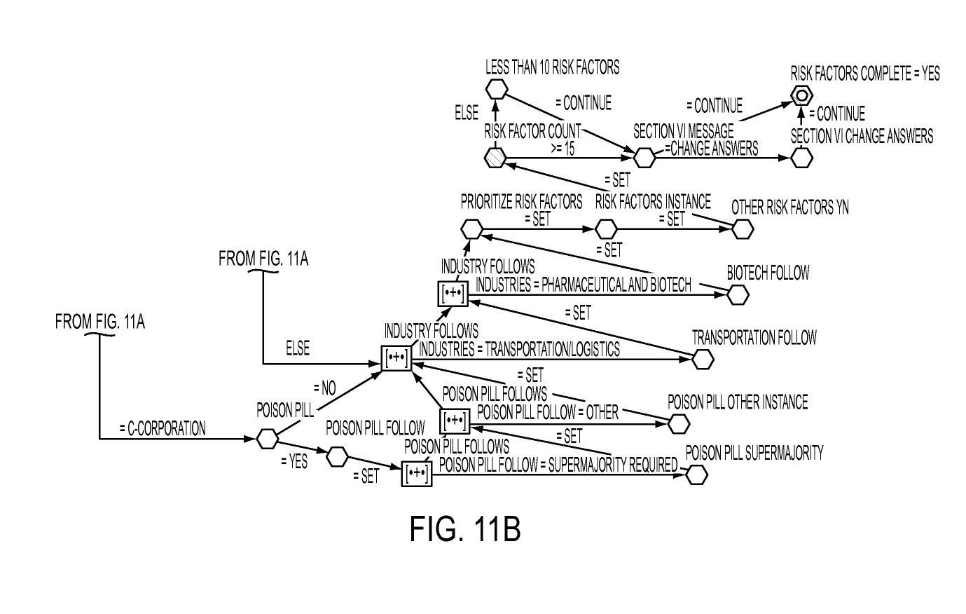

FIG. 11 illustrates processing for relating the raw disclosure information to be stored within the risk factor partition 222 as processed disclosure information. The information contained within the risk factor partition 222 relates to risks associated with the issuer and the offering. Based on the processed disclosure information contained within this and other partitions, a provisional set of risk factors are generated by the processor 232. The entity supplying the raw disclosure information, thereafter, has the opportunity to review, revise, and/or rank the provisional set of risk factors, which are then stored within the risk factor partition 222. Additionally, if the issuer's entity type (identified in the issuer partition 212) is a corporation, additional raw disclosure information is received regarding potential poison pill provisions of the issuer. The raw disclosure information stored within the risk factor partition 222 of the structured database includes, for example, factors that pose substantial risks to an investor in the offering in view of all facts and circumstances or which otherwise make the offering one of high risk or speculative. The risk factors may be due to, for example, cash flow and liquidity problems, inexperience of management, dependence of the issuer on an unproven product or absence of an existing market for the product, absence of an operating history of the issuer, absence of profitable operations in recent periods, an erratic financial history, the financial position of the issuer, the nature of the business in which the issuer is engaged or proposes to engage, arbitrary establishment of offering price, reliance on the efforts of a single individual, absence of a trading market if a trading market is not expected to develop, and any poison pills applicable to the issuer. A poison pill is a business strategy that attempts to create a shield against a takeover bid by another company.

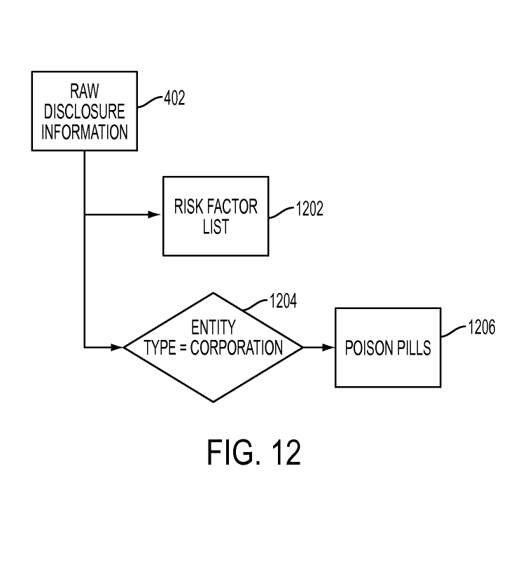

FIG. 12 depicts illustrative processing of the raw disclosure information 402 for configuration within the risk factor partition 222. The processor 232 performs the functions described with reference to FIG. 12. The raw disclosure information 402 is processed to determine whether the issuer has risk factors. This information may be derived from the un-stored raw disclosure information 402 and/or from processed disclosure information stored within one or more partitions other than the risk factor partition 222. This information is processed to produce a provisional set of risk factors that are stored in a risk factor list section 1202 of the risk factor partition 222. The entity type of the issuer is also determined using the processed disclosure information contained within the issuer partition 212 (illustrated as 1204).

Moreover, the processed disclosure information stored within the issuer partition 212 and/or the securities/offering partition 214 may be processed to determine whether additional risk factors should be included within the risk factor partition 222 (not illustrated). For example, depending on the entity type stored within the issuer partition 212 and/or the security type stored within the securities/offering partition 214, additional risk factors may be generated by the processor 232 and stored within the risk factor partition 222 as processed disclosure information.

If the issuer is a corporation, poison pill information is identified from the raw disclosure information 402 previously received or raw disclosure information 402 received subsequent to determining the issuer is a corporation. This poison pill information is thereby stored within a poison pills section 1206 of the risk factor partition 222. The subsequently received raw disclosure information may include data relating to whether the issuer's shareholder agreement contains any poison pill provisions.

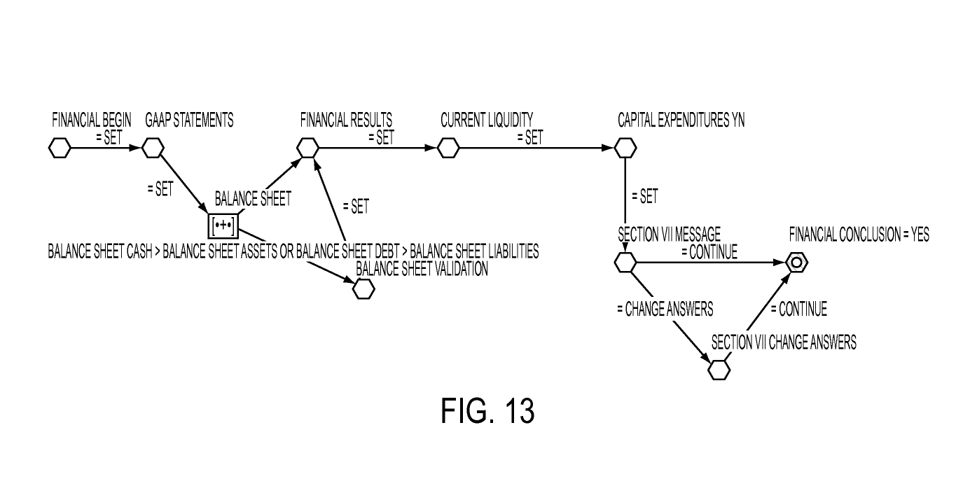

FIG. 13 illustrates processing of the raw disclosure information to be stored within the financial condition partition 224 as processed disclosure information. The information contained within the financial condition partition 224 relates to the financial history of the issuer. Depending upon the financial history data contained in the raw disclosure information, subsequent raw disclosure information may be solicited in order to gather follow-up information pertaining to the financial history of the issuer. The processed disclosure information stored within the financial condition partition 224 of the structured database includes, for example, the issuer's historical financial results of operations including any significant components of revenue and/or expenses, the current liquidity needs of the issuer and factors that affect the issuer's amount of liquidity, the effect the proceeds of the offering will have on operations, the effect any other known or pending sources of capital will have on operations, available sources of capital to the business such as lines of credit or required contributions by shareholders, prior material capital expenditures and future material capital expenditure commitments of the issuer, arrangements, understandings, or agreements that don't appear in the financial statements of the issuer that have an effect in the future on the issuer's financial condition, any material changes in the issuer's business or results of operations since the latest data of provided financial statements, any events, trends, or uncertainties that could have an effect on the issuer's financial condition, and whether the issuer has capital lease obligations, operating lease obligations, purchase obligations, or other long-term liabilities. The financial condition partition 224 further contains uploaded financial statements and tax returns.

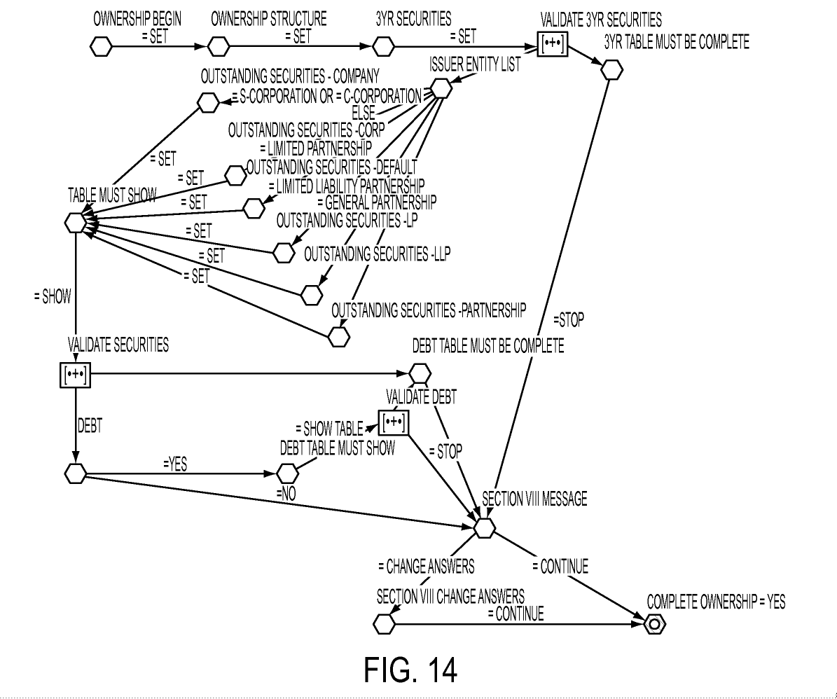

FIG. 14 illustrates processing of the raw disclosure information to be stored within the ownership partition 226 as processed disclosure information. The information contained within the ownership partition 226 relates to the issuer's outstanding securities, any offering conducted within the previous three years by the issuer, and any outstanding debt of the issuer. The processed disclosure information stored within the ownership partition 226 of the structured database includes, for example, the ownership structure of the issuer, information about the outstanding securities of the issuer, information about the indebtedness of the issuer, and whether the issuer has offered or sold any securities in the past three years. The outstanding securities information includes the type and name of the security, the amount outstanding, any voting rights and limitations on voting rights, any anti-dilution rights and put or call rights, and the way the securities may limit, dilute, or qualify the securities being offered. The indebtedness information includes the type and name of the debt, the name of the creditor, the amount outstanding, the interest rate and payment schedule, an amortization schedule, the collateral or security, the maturity date, and any other relevant material term. The previous offerings information includes a description of the offering, the type of securities and how many were sold, the amount of money raised, how the proceeds were used, the date of the offering, and, if applicable, an exemption from registration that was relied upon.

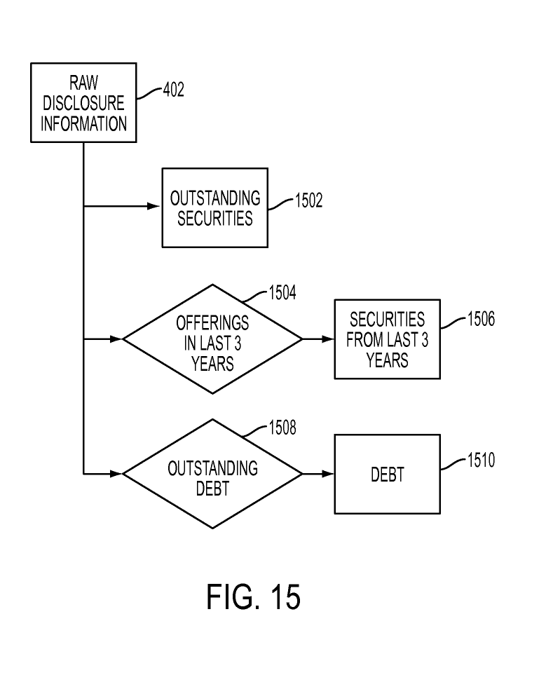

FIG. 15 depicts illustrative processing of the raw disclosure information 402 for configuration within the ownership partition 226 of the structured database 210. The processor 232 performs the functions described with reference to FIG. 15. If the raw disclosure information 402 contains information pertaining to outstanding securities of the issuer, that information is stored within an outstanding securities section 1502 of the ownership partition 226. The raw disclosure information 402 is processed to determine whether the issuer conducted any offerings within the previous three years (illustrated as 1504). If the issuer did conduct such an offering(s), the information pertaining thereto is stored within a securities from last 3 years section 1506 of the ownership partition 226. Moreover, the raw disclosure information 402 is processed to determine whether the issuer has any outstanding debt (illustrated as 1508). If the raw disclosure information 402 contains outstanding debt data, that data is stored within a debt section 1510 of the ownership partition 226.

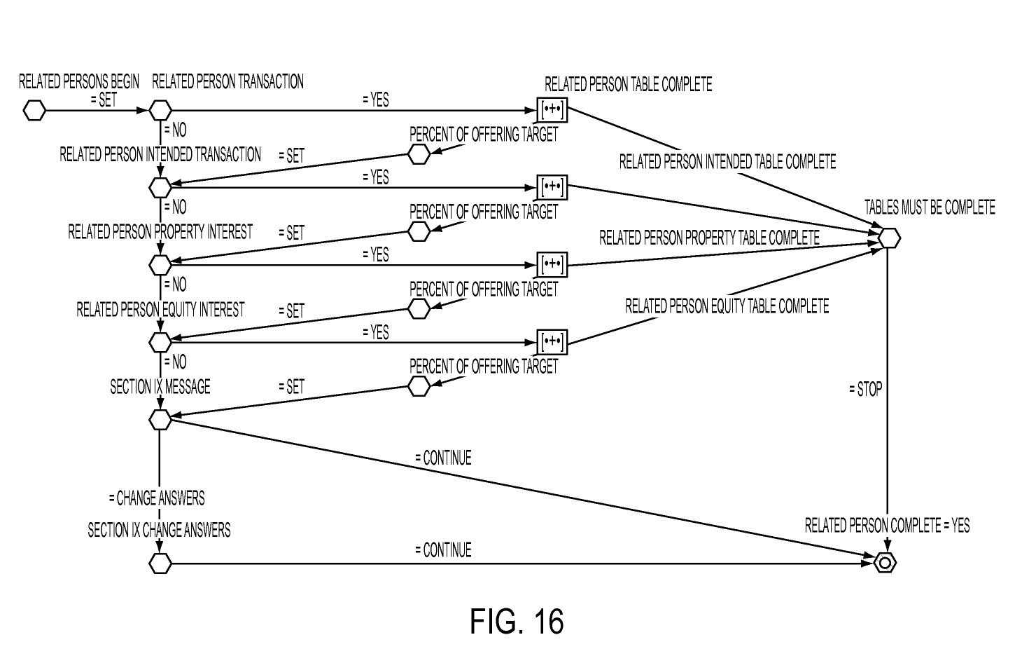

FIG. 16 illustrates processing of the raw disclosure information to be stored within the related party transaction partition 228 as processed disclosure information. The information contained within the related party transaction partition 228 relates to related party transactions entered into by the issuer. The information stored within this partition may be a series of sub-lists based on the type of transaction entered into. Further, the information stored within the related party transaction partition 228 may be used to populate one or more tables in the PPM or other disclosure document. The processed disclosure information stored within the related party transaction partition 228 of the structured database includes at a high level, for example, related person transactions, future related person transactions, related person equity transactions, and related person property transactions. Moreover, the related party transaction partition 228 has stored therein, for example, whether the issuer or any of its affiliates have conducted any transaction or entered into any agreement or arrangement with or affecting any related person. If so, further raw disclosure information may be stored such as, for example, a description of each transaction, arrangement, or agreement, the total amount of money involved, who the related person is and what is their relationship to the issuer, and what benefits or compensation the related person received. The raw disclosure information stored within the related party transaction partition 228 further includes, for example, whether the issuer or any of its affiliates intend to conduct any transaction with or affecting any related person in the future, and details pertaining to such future scenario.

For each indicated transaction involving a related person, it is determined the percentage of the offering target for which the transaction represents.

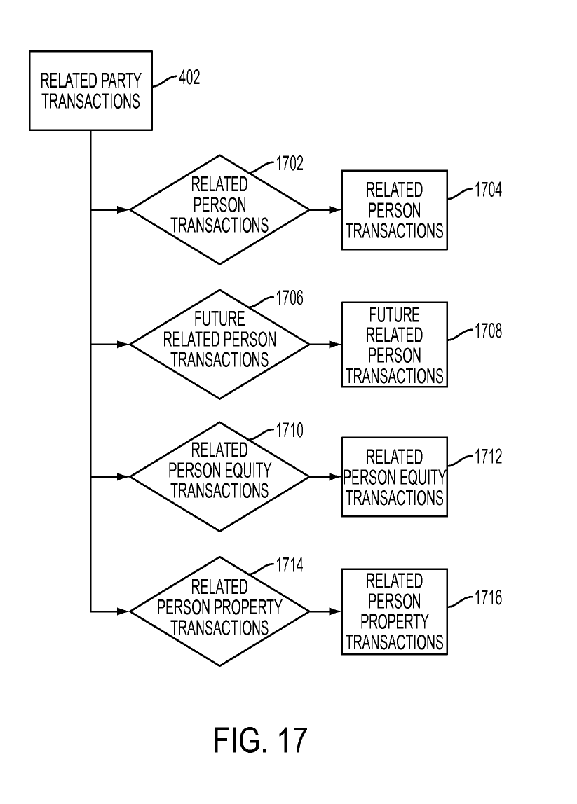

FIG. 17 depicts illustrative processing of the raw disclosure information 402 for configuration within the related party transaction partition 228. The processor 232 performs the functions described with reference to FIG. 17. The raw disclosure information 402 is processed to determine whether the issuer has entered into any related person transactions (illustrated as 1702), is going to enter into any related person transaction (illustrated as 1706), has entered into any related person equity transactions (illustrated as 1710), or has entered into any related person property transactions (illustrated as 1714). If any of this information is present, that information is stored within a related person transaction section 1704, future related person transactions section 1708, related person equity transactions section 1712, or related person property transactions section 1716 of the related party transaction partition 228 respectively.

The other supplied data partition 230 contains processed disclosure information, based on raw disclosure information, relating to other information about the issuer or the offering that does not fit within any of the aforementioned partitions. Thus, the processed disclosure information stored within the other supplied data partition 230 of the structured database includes any information not stored within any other partition that would be important to a potential investor in determining whether to purchase the securities being offered. For example, such information includes material information that must be disclosed prior to the offering, and any attestations by the issuer.

The processed disclosure information related to a file identifier, i.e., specific to a single offering, located in various partitions of the structured database as described hereinbefore, is automatically conformed to a PPM or other reporting document structure. Information contained within a single area of the document may be derived from processed disclosure information contained in different partitions of the structured database. Moreover, information contained within the document is automatically edited/changed according to the processed disclosure information related to the file identifier. That is to say, each generated document may have different information/structure depending on the processed disclosure information used to generate the document. Only relevant processed disclosure information is automatically conformed to the document. Put another way, only relevant fields of the document are displayed and auto-populated, for example within a PPM form. The automatic generation of the document may utilize, for example, plain-language mark-up. Furthermore, the information used from the structured database to generate the document may be stored as an answer set in, for example, XML.

To populate the PPM or other document, the issuer name, which is stored within the issuer partition 212, may be populated using an automation tool such as ContractExpress™ available from Business Integrity, Inc. of London and New York. When the issuer name is selected by an individual desiring the PPM or other document to be generated, the automation tool is used to locate the session ID associated with the issuer name stored within the issuer partition 212. The session ID is thereby passed to the automation tool to provide the relevant data from the associated partitions that are related to the issuer name or file identification. This relevant data is used to further populate the PPM or other document.

Throughout the PPM or other document, there may be variable sections that display information produced from processed disclosure information stored within multiple partitions of the disclosure information structured database 210. For example, further processing may determine the percentage of all outstanding securities that will be owned by a small number of shareholders after the offering is concluded by manipulating: (1) the number of currently outstanding securities, stored within the issuer partition 212; (2) the number of securities being offered in the present offering, stored within the securities/offering partition 214; (3) the number of securities owned by management, stored within the staff partition 216; and (4) the number of securities owned by all owners who own more than 20% of outstanding shares before the offering, stored within the shareholder partition 218. This generated value, i.e., the percentage of all outstanding securities that will be owned by a small number of shareholders after the offering, may be further used to automatically determine whether a certain risk factor should be included within the risk factor partition 222 and also to determine what value that risk factor should have. If this additional risk factor should be included, the additional risk factor is populated within the risk factor partition 222 and within the PPM or other document.

If poison pill data is evidenced within the processed disclosure information of the risk factor partition 222, risk factors associated with the poison pill data are included within the PPM or other document.

The PPM or other document may contain reference to specific rules, e.g., state law, pertaining to the offering. These rules may be gathered from or using the information stored within the specific rules database disclosed herein. For example, the processor 232 may evaluate the processed disclosure information of the issuer partition 212, related to the session ID affiliated with the selected issuer name detailed above, to determine whether the formation state of the issuer is Delaware. If the formation state is Delaware, a provision referencing Delaware General Corporation Law is included within the PPM or other document.

The PPM or other document may further contain a series of tables in an Equity Compensation section. These series of tables may contain merged processed disclosure information gathered from the staff partition 216 of the structured database 210. More specifically the information contained within the management compensation section or field 708, current year compensation (e.g., equity) section 710, previous year compensation (e.g., equity) section 712, and management with equity section 716 are merged with information stored within the officers and directors sections 702, 704. Moreover, processed disclosure information stored within the management with equity section 716 of the staff partition 216 may be merged with the processed disclosure information contained within the voting ownership and aggregate ownership section 902, 904 of the shareholder partition 218 to create one or more equity holder tables within the PPM or other document.

A red flag may be triggered in a risk report that accompanies the PPM or other document if the amount of securities outstanding after the offering could exceed the number of securities available under the issuer's charter. For example, the processor 232 may evaluate the processed disclosure information contained within the issuer partition 212 to determine whether the entity is a Limited Liability Company (“LLC”) or a Corporation. The processor 232 may also evaluate the processed disclosure information contained within the securities/offering partition 214 to determine whether the company will be offering LLC securities, such as LLC units, or corporation securities, such as shares of common stock. Depending upon these determinations, the processor 232 manipulates the number of securities to be offered in the offering (including possible oversubscriptions, stored within the securities/offering partition 214, and the number of issuer securities currently outstanding, stored within the issuer partition 212, to determine the maximum number of securities outstanding after the offering. The processor 232 compares that value with the number of securities authorized in the issuer's charter, which is stored within the issuer partition 212. If the maximum number of securities outstanding after the offering is determined to be greater than the number of securities authorized in the issuer's charter, a red flag is triggered in the risk report.

In another example, a red flag is created within the risk report if the issuer was formed in a foreign jurisdiction, as evidenced by the processed disclosure information stored within the issuer partition 212. A risk factor corresponding to this red flag may or may not be created and stored within the risk factor partition 222.

In a further example, a red flag is created within the risk report if any of the related party transactions evidenced in the related party transaction partition 228 exceed a certain threshold value of the offering target, evidenced in the securities/offering partition 214. This threshold value may be 5% of the offering target.

The systems and methods have been described herein with relation to general security/interest offerings. In an implementation, the systems and methods may be configured to accommodate property offerings, e.g., real estate offerings. This is beneficial for various entities, such as real estate holding companies, that offer equity interests in property developments and sets of properties. It should be appreciated by one skilled in the art that, for this particular implementation, the structure of the database, i.e., the partitions, and the processed information contained within each partition will be optimized as a function of the nature of the implementation, i.e., property/real estate offerings.

According to the present disclosure, if the entity providing the raw disclosure information wants to provide the raw disclosure information in portions/batches, the entity may need to save their session. When the entity returns, they may need to select their previous session in order to identify what they have already provided, so there is no duplicate raw disclosure information contained within the database specific to a single offering. However, one skilled in the art should appreciate that the systems and methods disclosed herein may include an auto-resume feature/function that allows the entity's progress to be automatically saved at various times/intervals while they are providing the raw disclosure information. This allows the entity to merely return to a single URL used by the entity to previously provide the raw disclosure information, instead of having to return to the URL and further select their previous session.

The risk factor partition has been described to include various types of risk factors, both issuer identified and processor created. One skilled in the art should appreciate these risk factors to be a non-limiting list, and that broader or narrower risk factors than those explicitly described may be involved in the systems and methods disclosed herein. This may allow the risk factors associated with each offering to be specifically and beneficially tailored to the specific issuer conducting each offering.

As described herein, each PPM or other document may be populated by processed disclosure information gathered entirely from newly supplied raw disclosure information. However, one skilled in the art should appreciate that a PPM or other document may be created from both newly processed disclosure information gathered entirely from newly supplied raw disclosure information as well as previously processed disclosure information gathered for generation of a previous PPM or other document. This may entail the creation of a unique file identifier or session ID that links the newly processed disclosure information with relevant previously processed disclosure information.

While not explicitly illustrated, the systems and methods disclosed may include a database management system (“DBMS”) that creates and manages the databases described herein. The DBMS may be implemented as a software package. An example of such DBMS is SharePoint®.

The computer systems and servers described herein each contain a memory that will configure associated processors to implement methods, steps, and functions described. Such methods, steps, and functions may be carried out, e.g., by processing capability on various system elements or by any combination of elements. The memories can be distributed or local and the processors can be distributed or singular. The memories can be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor may retrieve the information from the network.

Accordingly, it will be appreciated that one or more aspects of a system may include a computer program comprising computer program code means adapted to perform one or more steps described when such program is run on a computer, and that such program may be embodied on a tangible computer readable recordable storage medium; for example, in the form of distinct software modules which then execute on one or more hardware processors. Further, a system may include a computer comprising code adapted to cause the computer to carry out one or more steps, together with one or more apparatus elements or features. In various embodiments, software may be implemented in hardware components such as application specific integrated circuits (ASICs). Implementation of a hardware state machine to perform the functions described herein will be apparent to persons skilled in the relevant art(s).

Computers discussed herein may be interconnected, for example, by one or more of network, another virtual private network (VPN), the Internet, a local area and/or wide area network (LAN and/or WAN), via an EDI layer, and so on. The computers may be programmed, for example, in compiled, interpreted, object-oriented, assembly, and/or machine languages, for example, one or more of C, C++, Java, Visual Basic, and the like (an exemplary and non-limiting list), and may also make use of, for example, Extensible Markup Language (XML), known application programs such as relational database applications, spreadsheets, and the like. The computers may be programmed to implement the methods, steps and logic described.

As described herein a network may include any cloud, cloud computing system or electronic communications system or method which incorporates hardware and/or software components. Communication among the parties may be accomplished through suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse, combinations thereof and/or any suitable communication or data input modality.

Databases or data warehouses discussed herein may include relational, hierarchical, graphical, or object-oriented structure. Moreover, the databases may be organized in any of various suitable manners, for example, as data tables or lookup tables. Each record may be a single file, a series of files, a linked series of data fields or other data structure. Association of certain data may be accomplished through desired data association techniques such as those known or practiced in the art.

The computers discussed herein may provide a suitable website or other Internet-based graphical user interface which is accessible by users.

As should be appreciated by one of ordinary skill in the art, the improved system described herein may be embodied as a customization of an existing system, an add-on product, a processing apparatus executing upgraded software, a stand-alone system, a distributed system, a method, a data processing system, a special purpose device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, may be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, may be implemented by either special purpose hardware-based computer systems which perform the specified functions or steps, or suitable combinations of special purpose hardware and computer instructions.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. It should be appreciated that in the appended claims, reference to an element in the singular is not intended to mean “one and only one” unless explicitly so stated, but rather “one or more.”

Although illustrative embodiments of the present disclosure have been described herein with reference to the accompanying drawings, it is to be understood that the present disclosure is not limited to those precise embodiments, and that various other changes and modifications may be made by one skilled in the art without departing from the scope or spirit of the disclosure.

What is claimed is:

1. A machine for building a structured database to process and provide disclosure information compliant with specific rules, comprising:
a memory including a specific rules database and a disclosure information database, the specific rules database including rules pertaining to offerings, the disclosure information database having a structured partition for each of processed business description information, processed offering information, processed staff information, processed shareholder information, processed risk factor information, processed financial condition information, processed ownership information, and processed related party transaction information; and
a processor in communication with the memory, the processor parsing raw disclosure information and storing the parsed raw disclosure information within structured partitions of the disclosure information database as processed disclosure information, the processor selectively processing the processed disclosure information stored in specific structured partitions of the disclosure information database to determine portions of the processed disclosure information to be used in automatically constructing an offering document.

2. The machine of claim 1, wherein an issuer partition includes a doing business as names structured dataset, a formerly known as names structured dataset, and a subsidiary information structured dataset.

3. The machine of claim 1, wherein a staff partition includes an officer information structured dataset and a director information structured dataset.

4. The machine of claim 1, wherein a shareholder partition includes a voting ownership information structured dataset and an aggregate ownership information structured dataset.

5. The machine of claim 1, wherein a risk factor partition includes a poison pill information structured dataset that contains poison pill information specific to offerings having a corporation as an issuer.

6. The machine of claim 1, wherein an ownership partition includes an outstanding securities information structured dataset and an issuer debt information structured dataset.

7. The machine of claim 1, wherein a related party transaction partition includes a related person equity transactions structured dataset and a related person property transactions structured dataset.

8. A method of building a structured dataset in a database to provide processed disclosure information processed to be compliant and presented in accordance with specific rules, comprising the steps of:
providing a structured database for processed disclosure information, the structured database having a structured partition for each of business description information, offering information, staff information, shareholder information, risk factor information, financial condition information, ownership information, and related party transaction information;
receiving raw disclosure information from an entity via a network;
parsing the raw disclosure information and processing the parsed raw disclosure information for storage within the structured partitions of the structured database as processed disclosure information;
storing the processed disclosure information within individually structured portions of the structured partitions, the processed disclosure information located within various structured partitions related to an offering being electronically associated by an offering file; and
formatting and electronically presenting the processed disclosure information electronically associated with the offering file in a manner compliant with the specific rules.

9. The method of claim 8, further comprising the step of:
processing the processed disclosure information within specific structured partitions of the structured database to determine a percentage of outstanding securities to be owned by a number of shareholders after an offering, the specific structured partitions including a structured issuer partition, a structured offering partition, a structured staff partition, and a structured shareholder partition.

10. The method of claim 9, further comprising the step of:
processing the determined percentage of outstanding securities to be owned by a number of shareholders after the offering to determine whether an additional risk factor should be generated and stored within a structured risk factor partition.

11. The method of claim 8, wherein the formatting step includes processing the processed disclosure information stored within a structured staff partition for presentment as a particularized management compensation table.

12. The method of claim 8, wherein the formatting step includes processing the processed disclosure information stored within a structured staff partition with processed disclosure information stored within a structured shareholder partition to present a particularized equity holder table.

13. The method of claim 8, further comprising the step of:
processing the processed disclosure information with specific rule information to generate a red flag within a risk report when the processed disclosure information electronically related by the offering file does not conform to relevant specific rules.

14. The method of claim 13, further comprising the step of:
processing the processed disclosure information stored within a structured issuer partition and a structured offering partition to determine when a calculated amount of securities outstanding after an offering exceeds a number of securities available.

15. A system containing a structured database of processed disclosure information used to generate an offering document comprising:
an issuer computer receiving raw disclosure information; and
a processing computer receiving the raw disclosure information from the issuer computer and parsing the raw disclosure information, the processing computer further processing the parsed raw disclosure information into processed disclosure information stored within structured partitions of the structured database, the processed disclosure information specific to an offering being electronically related across structured partitions by a unique file identifier, the processing computer processing the processed disclosure information electronically related by a unique file identifier for presentment within a disclosure document, the disclosure document and the processed disclosure information contained therein complying with offering rules.

16. The system of claim 15, wherein the processing computer transmits the disclosure document to a portal upon conducting a compliance analysis on the disclosure document, the compliance analysis determining whether the disclosure document complies with the offering rules.

17. The system of claim 15, wherein the processing computer stores a portion of the processed disclosure information within a structured partition containing risk factor information.

18. The system of claim 17, wherein the processing computer generates the risk factor information using processed disclosure information stored within multiple structured partitions of the structured database.

19. The system of claim 15, wherein the processing computer modifies the disclosure document to include optional portions triggered by specific processed disclosure information.

20. The system of claim 15, wherein the processing computer modifies the disclosure document to include portions of the offering rules when an issuer of an offering has a certain state of formation.
